(19) United States
(12) Patent Application Publication
(10) Pub. No.: US 2009/0321399 A1
(43) Pub. Date: Dec. 31, 2009

(54) DYNAMIC SCRIBE ALIGNMENT FOR LASER SCRIBING, WELDING OR ANY PATTERNING SYSTEM

(75) Inventors: Makoto Inagawa, Palo Alto, CA (US); Shinichi Kurita, San Jose, CA (US); Bassam Shamoun, Fremont, CA (US); Sriram Krishnaswami, Saratoga, CA (US); Michael D. Shirk, Brentwood, CA (US); Kevin L. Cunningham, Mountain View, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/422,208

(22) Filed: Apr. 10, 2009

Related U.S. Application Data
(60) Provisional application No. 61/044,390, filed on Apr. 11, 2008.

(51) Int. Cl. B23K 26/38

(52) U.S. Cl. 219/121.69; 219/121.68

(57) ABSTRACT

Methods and systems for improving the alignment between a previously formed feature and a subsequently formed feature are provided. An exemplary method can include laser scribing a workpiece (104, 550) having a previously formed first feature. The exemplary method includes imaging the workpiece (104, 550) with an imaging device (320, 420, 554, 640) so as to capture a plurality of positions of the first feature on the workpiece (104, 550) relative to the laser-scribing device (100). The exemplary method further includes using the captured positions to align output from the laser-scribing device (100) in order to form a second feature on the workpiece (104, 550) at a controlled distance from the first feature.

### CROSS-REFERENCE TO RELATED APPLICATIONS

This application claims the benefit of U.S. Provisional Patent Application No. 61/044,390, filed Apr. 11, 2008, entitled “Dynamic Scribe Alignment for Laser Scribing, Welding or any Patterning System,” which is hereby incorporated herein by reference.

### BACKGROUND OF THE INVENTION

Various embodiments described herein relate generally to laser scribing, welding, or patterning of materials, and more particularly to systems and methods for forming features positioned relative to previously formed features on a workpiece. These systems and methods can be particularly effective for laser scribing thin-film single-junction and multi-junction solar cells.

Current methods for forming thin-film solar cells involve depositing or otherwise forming a plurality of layers on a substrate, such as a glass, metal or polymer substrate suitable to form one or more p-n junctions. An exemplary thin solar cell includes a transparent conductive oxide (TCO) layer, a plurality of doped and undoped silicon layers, and a metal back layer. A series of laser-scribed lines is typically used to create individual cells connected in series. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is being formed from a large substrate, a series of laser-scribed lines is typically used within each layer to delineate the individual cells. FIG. 1A-1E illustrate one such method for forming thin-film solar cells using laser-scribed lines. FIG. 1A illustrates the first step in the formation of a thin-film solar cell, where a TCO layer 11 is deposited on a glass substrate 10. FIG. 1B illustrates the second step, where a first set of lines 12 (herein referred to as “P1” lines) are laser scribed in the TCO layer 11. FIG. 1C illustrates the third step, where a plurality of doped and undoped silicon layers 13 are deposited on top of the TCO layer 11 and within the scribed P1 lines 12. FIG. 1D illustrates the fourth step, where a second set of lines 14 (“P2” lines) are laser scribed in the amorphous silicon (a-Si) layer 13. FIG. 1E illustrates the fifth step, where a metal layer 15 is deposited on top of the amorphous silicon (a-Si) layer 13 and within the scribed P2 lines 14. FIG. 1E also illustrates the sixth step, where a third set of lines 16 (“P3” lines) are laser scribed in the metal layer 15.

Current thin-film solar cells suffer from low efficiency. The low efficiency can be attributed in part due to the inherent efficiency of the solar cell design and in part due to the manufacturing equipment used.

Accordingly, it is desirable to develop improved systems and methods that overcome at least some of these, as well as potentially other, deficiencies in existing manufacturing equipment, solar panel manufacturing, and other such devices. Additionally, such a need for improved systems and methods may also exist for welding or other patterning systems.

### BRIEF SUMMARY OF THE INVENTION

Methods and systems in accordance with various embodiments provide for more accurate relative positioning or alignment between features formed on a workpiece, such as by laser scribing, welding, or patterning. These systems and methods can be particularly effective for laser scribing thin-film multi-junction solar cells.

Methods for laser scribing a workpiece having a first scribed feature are provided in accordance with various embodiments. An exemplary method includes using a laser-scribing device to laser scribe the workpiece. The exemplary method further includes imaging the workpiece with an imaging device so as to capture a plurality of positions of the first feature on the workpiece relative to the laser-scribing device, and using the captured positions to align output from the laser-scribing device in order to form a second feature on the workpiece at a controlled distance from the first feature.

Systems for aligning a laser for scribing a workpiece having a first scribed feature are provided in accordance with various embodiments. An exemplary system can include: a laser operable to generate output able to remove material from at least a portion of a workpiece; a scanning device operable to control a position of the output of the laser relative to the workpiece; an imaging device having a pre-determined orientation relative to the scanning device; and a control device coupled with the laser, the scanning device and the imaging device. The control device comprises a processor and a machine-readable medium comprising instructions that when executed by the processor cause the system to: image the workpiece using the imaging device so as to capture a plurality of positions of the first feature on the workpiece; and use the captured positions to align the laser output using the scanning device in order to form a second feature on the workpiece at a controlled distance from the first feature.

Systems for aligning an energy source for patterning a workpiece having a first formed feature are provided. An exemplary system comprises: an energy source operable to generate output able to contribute to the formation of a feature on a workpiece; a scanning device operable to control a position of the output from the energy source relative to the workpiece; an imaging device having a pre-determined orientation relative to the scanning device and operable to image a feature on the workpiece; and a control device coupled with the energy source, the scanning device and the imaging device. The control device comprises a processor and a machine-readable medium comprising instructions that when executed by the processor cause the system to: image the workpiece using the imaging device so as to capture a plurality of positions of the first feature on the workpiece; and use the captured positions to align the energy source output using the scanning device in order to form a second feature on the workpiece at a controlled distance from the first feature.

For a fuller understanding of the nature and advantages of the present invention, reference should be made to the ensuing detailed description and accompanying drawings. Other aspects, objects and advantages of the various embodiments will be apparent from the drawings and detailed description that follows.

### BRIEF DESCRIPTION OF THE DRAWINGS

FIG. 1A-1E illustrate an exemplary method for forming thin-film solar cells using laser-scribed lines, in accordance with embodiments.

FIG. 2 illustrates a perspective view of a laser-scribing device that can be used in accordance with embodiments.

FIG. 3 illustrates an end view of a laser-scribing device that can be used in accordance with embodiments.

FIG. 4 illustrates components of a laser assembly that can be used in accordance with embodiments.

FIG. 5 illustrates the generation of multiple scan areas that can be used in accordance with embodiments.

FIG. 6 illustrates an imaging device relative to a scan area in a laser-scribing device that can be used in accordance with embodiments.

FIG. 7 shows a camera mounted between the laser and the scanner device so that the camera views the workpiece through the scanning device, in accordance with embodiments.

FIG. 8 diagrammatically illustrates the integration of the camera shown in FIG. 9, showing how the use of a beam splitter allows the camera to view the workpiece through the scanning device, in accordance with embodiments.

FIG. 9A-9D illustrate how the camera displayed in FIG. 9 can be used to implement DSA (Dynamic Scribe Alignment) by adjusting the alignment of the position of the scribing laser output relative to previously laser-scribed lines (e.g., P11 line) on the workpiece so that the distance between previously laser-scribed lines (e.g., P11 line) and the subsequently laser-scribed lines (e.g., P21 line) may be minimized in accordance with embodiments.

FIG. 10 is a simplified block diagram for a method for aligning output relative to a previously formed feature in accordance with embodiments.

FIG. 11 diagrammatically illustrates positional errors that may be induced by a scanning device.

FIG. 12 diagrammatically illustrates a method for compensating for positional errors that may be induced by a scanning device, in accordance with embodiments.

FIG. 13 diagrammatically illustrates the use of imaging devices to measure a width of a laser-scribed line, in accordance with embodiments.

FIG. 14 is a simplified diagram of a system for controlling a scanning device based upon image information of previously formed features, in accordance with an embodiment.

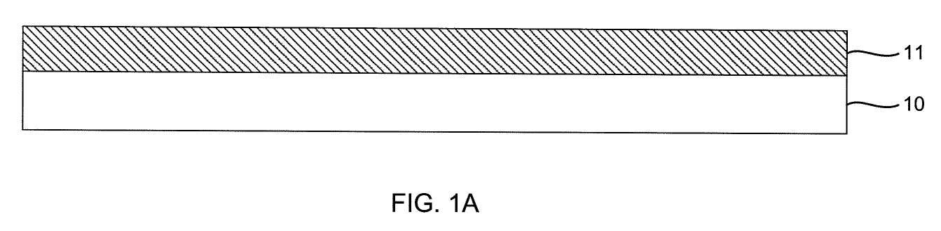

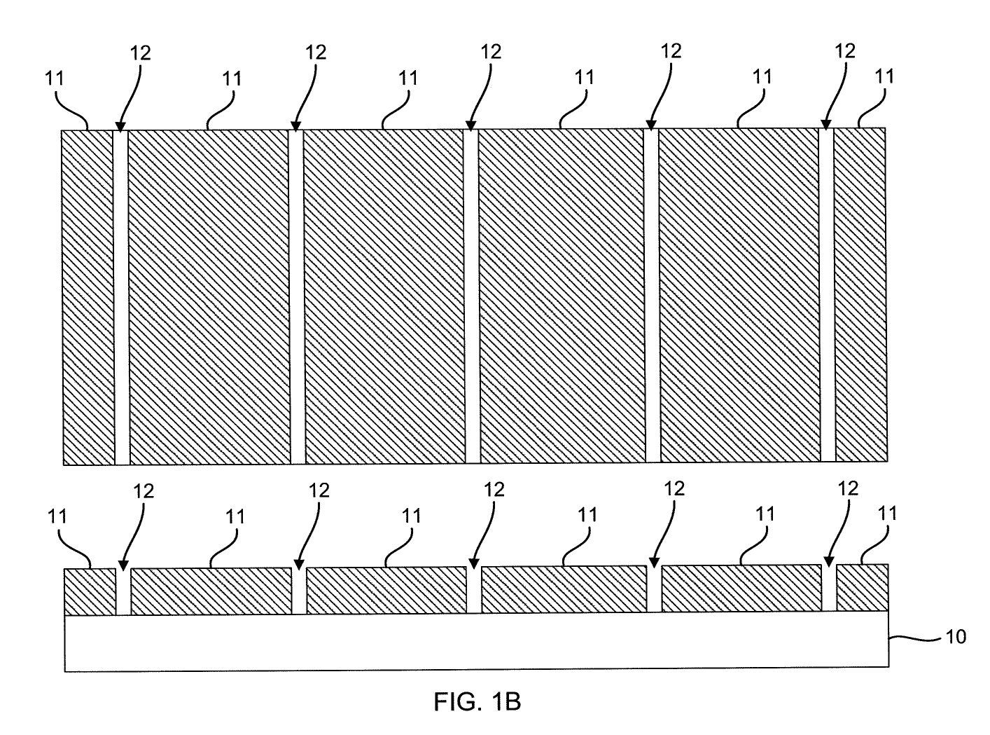

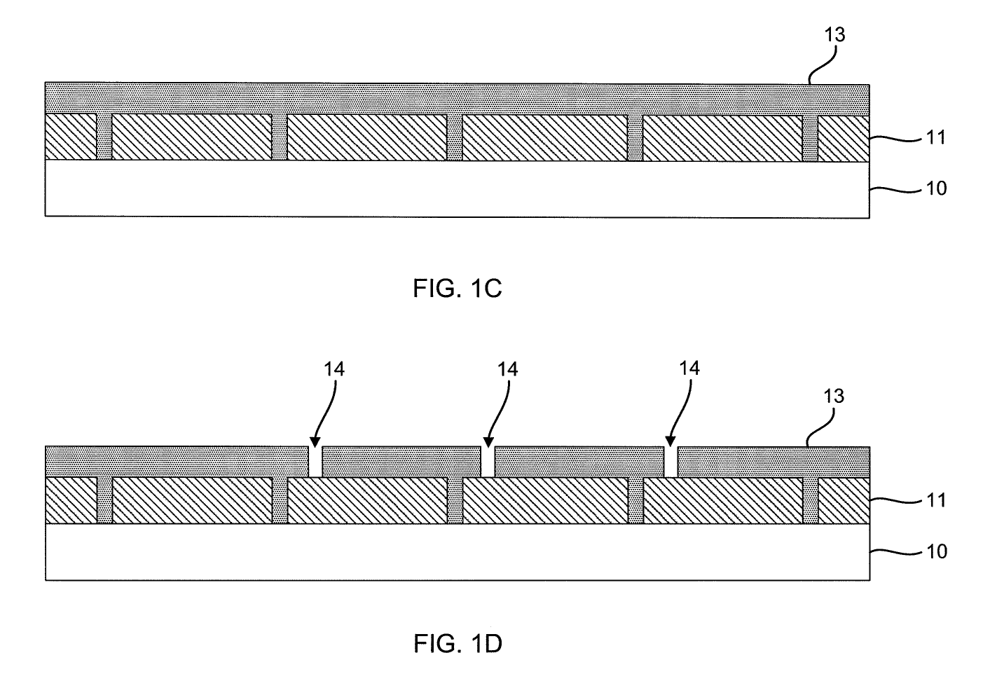

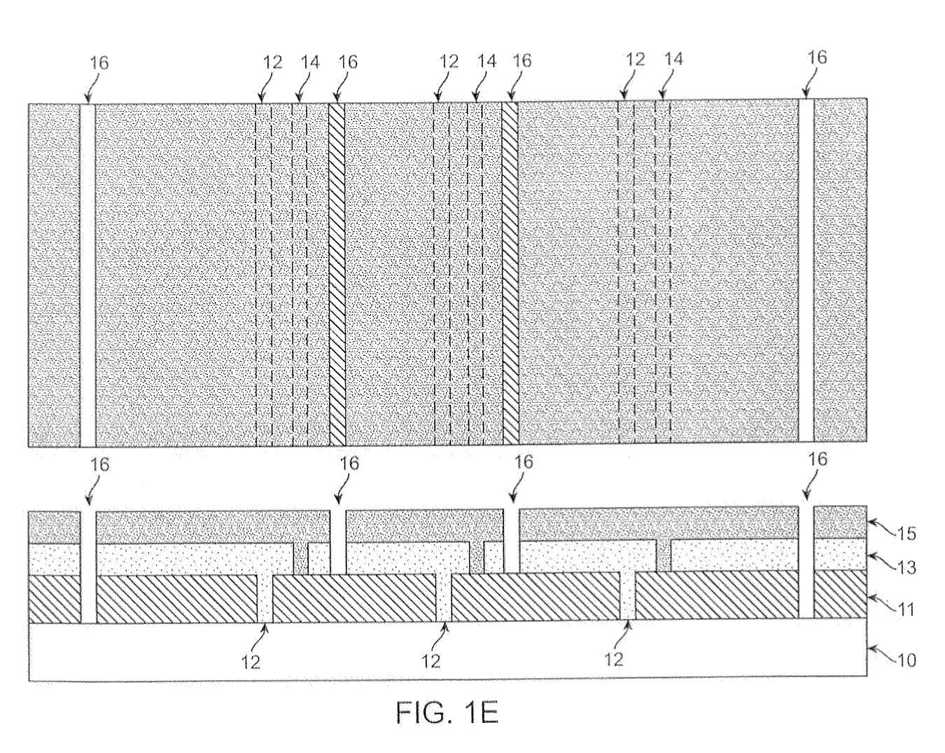

### DETAILED DESCRIPTION OF THE INVENTION

Systems and methods in accordance with various embodiments of the present disclosure relate generally to laser scribing, welding, or patterning of materials, and certain embodiments related more particularly to systems and methods for positioning or aligning subsequently formed features relative to previously formed features on a workpiece. Various embodiments can provide for more accurate alignment of subsequently formed features with previously formed features by using dynamic or “real time” alignment control (i.e., Dynamic Scribe Alignment or “DSA”) through the use of an imaging device that captures the relative position(s) of previously formed features. These systems and methods can be particularly effective for laser scribing thin-film multi-junction solar cells.

While current methods for forming thin-film solar cells result in a solar panel that has a majority of its area being active, various regions lying between the P1 12 and P3 16 scribe lines constitute non-active solar cell area (i.e., the “dead zone”). In order to optimize the efficiency of these solar cell panels, the dead zone of these panels should be minimized. To minimize the dead zone, the P3 line 16 should be aligned as close as possible to the P1 line 12. In previous approaches, it was hard to minimize this gap between the P3 16 and P1 12 lines in the scribe pattern due to the huge area of solar panel. Slight temperature changes would cause distortion or expansion of the panel or the laser-scribing system itself. Stage and mirror optics calibration noise, uncorrected mean errors, process induced geometrical distortions, material property inhomogeneities, and material thickness variations also contribute error to the scribing process. Therefore the scribe pattern had to be defined with a P3 and P1 gap that includes all the tolerances due to thermal or mechanical factors. The result was a large gap, a large dead zone, and consequently reduced solar panel efficiency. Further, there was also a need for frequent calibration due to long term thermal drift of the scan head. Even further still, to improve the alignment between two scribe lines, the straightness of both lines (e.g., P3 and P1 lines) had to be maintained.

In one embodiment, an imaging device is used to locate one or more previously formed laser-scribed lines and image-derived information is used to control where a subsequently formed laser-scribed line is located. The previously formed laser-scribed lines can be located using a look ahead and/or a look down process. The previously formed laser-scribed lines can be located just prior to the scribing of the subsequently formed laser-scribed lines, therefore reducing positional errors that may increase as time passes. Therefore, a subsequently laser-scribed line (e.g., P3 line) can located relative to a previously laser-scribed line (e.g., P1 or P2 line), and follow the form of the previously laser-scribed line, including any curvature, deviations, etc. This technique allows a subsequently laser-scribed line (e.g., P2 or P3 line) to be aligned as closely as possible to a specified distance relative to a previously laser-scribed line (e.g., P1 or P2 line).

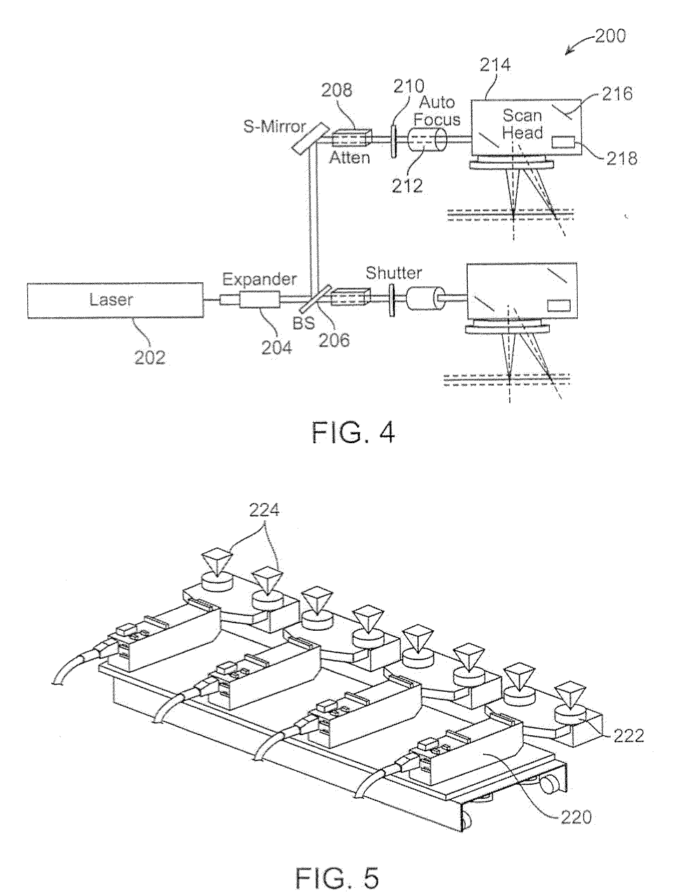

Using an imaging device to locate previously formed laser-scribe lines can be particularly advantageous where it is particularly important to minimize the distance between the scribed lines but not important to maintain the straightness of the scribed lines themselves. One example of such a situation would be to align the P3 line as closely as possible to the P1 line in order to minimize the dead zone (i.e., non-active solar cell area). Ideally, the subsequently laser-scribed line (e.g., P2 or P3 line) would be formed exactly parallel to the previously laser-scribed line (e.g., P1 or P2 line), with a minimum amount of space between them. However, the straightness of the laser-scribed lines is affected by factors such as the stage and mirror optics calibration noise, uncorrected mean errors, process induced geometrical distortions, material property inhomogeneities, and material thickness variations. The huge area of the solar panel workpiece also contributes to the variation, because slight temperature changes would cause distortion or expansion of the panel or the laser-scribing system itself. These thermal distortions become particularly problematic when the area of the solar panel workpieces exceeds 10,000 cm². An imaging device can be used to align the subsequently laser-scribed line (e.g., P2 or P3 line) as closely as possible to the previously laser-scribed line (e.g., P1 or P2 line), without having to maintain the straightness of both lines (e.g., P3 and P1 lines). Furthermore, the use of an imaging device also eliminates the need for frequent calibration due to long term thermal drift of the scan head 214 that is displayed in FIG. 4.

Laser-Scribing Devices

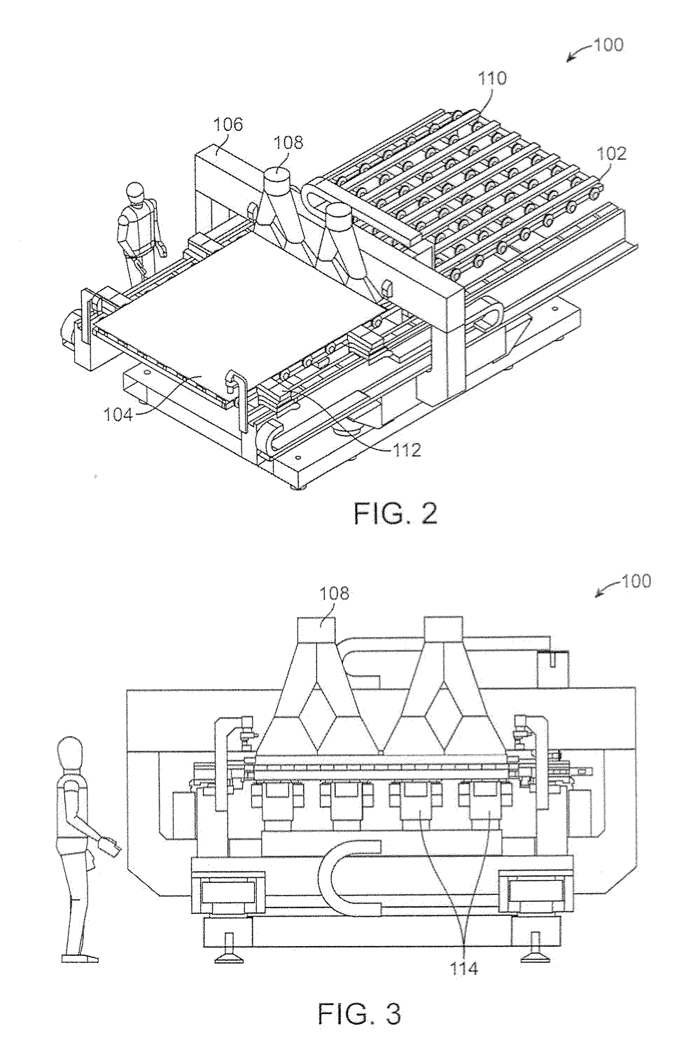

FIG. 2 illustrates an exemplary laser-scribing device 100 that can be used in accordance with one embodiment. The device includes a bed or stage 102, which will typically be leveled, for receiving and maneuvering a workpiece 104, such as a substrate having at least one layer deposited thereon. In one example, the substrate is moved at a rate of 0.5 m/s or more, such as about 2 m/s. Typically, the workpiece will be aligned to a fixed orientation with the long axis of the workpiece substantially parallel to the motion of the workpiece in the device. The alignment can be aided by the use of cameras or imaging devices that acquire marks on the workpiece. In this example, the lasers (shown in subsequent figures) are positioned beneath the workpiece and opposite an exhaust arm or gantry 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is received onto an array of rollers 110, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly. The device can include at least one controllable drive mechanism 112 for controlling a direction and translation velocity of the workpiece 104 on the stage 102. Further description about such a system and its use is provided in co-pending U.S. Provisional Application No. 61/044,390, which is incorporated by reference above.

FIG. 3 illustrates an end view of the exemplary laser-scribing device 100, illustrating a series of laser assemblies 114 used to scribe the layers of the workpiece. In this example, there are four laser assemblies 114, each including a laser device and elements, such as lenses and other optical elements, used to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. Each laser device actually produces two effective beams useful for scribing the workpiece. In order to provide the pair of beams, each laser assembly can include at least one beam splitting device. FIG. 4 illustrates basic elements of an exemplary laser assembly 200 that can be used in accordance with one embodiment, although it should be understood that additional or other elements can be used as appropriate. In assembly 200, a single laser device 202 generates a beam that is expanded using a beam expander 204 then passed to a beam splitter 206, such as a partially transmissive mirror, half-silvered mirror, prism assembly, etc., to form first and second beam portions. In this assembly, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, such as a galvanometer scanner useful as a directional deflection mechanism. In one embodiment, this is a rotatable mirror able to adjust the position of the beam along a latitudinal direction, orthogonal to the movement vector of the workpiece, which can allow for adjustment in the position of the beam relative to the intended scribe position.

In another embodiment, each scan head 214 includes a pair of rotatable mirrors 216, or at least one element capable of adjusting a position of the laser beam in two dimensions (2D). Each scan head includes at least one drive element 218 operable to receive a control signal to adjust a position of the “spot” of the beam within the scan field and relative to the workpiece. In one example, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece. For example, FIG. 5 illustrates a perspective view of exemplary laser assemblies. A pulsed beam from each laser 220 is split along two paths, each being directed to a 2D scan head 222. As shown, the use of a 2D scan head 222 results in a substantially square scan field for each beam, represented by a pyramid 224 exiting each scan head 222. By controlling a size and position of the square scan fields relative to the workpiece, the lasers 220 are able to effectively scribe any location on the substrate while making a minimal number of passes over the substrate. If the positions of the scan fields substantially meet or overlap, the entire surface could be scribed in a single pass of the substrate relative to the laser assemblies.

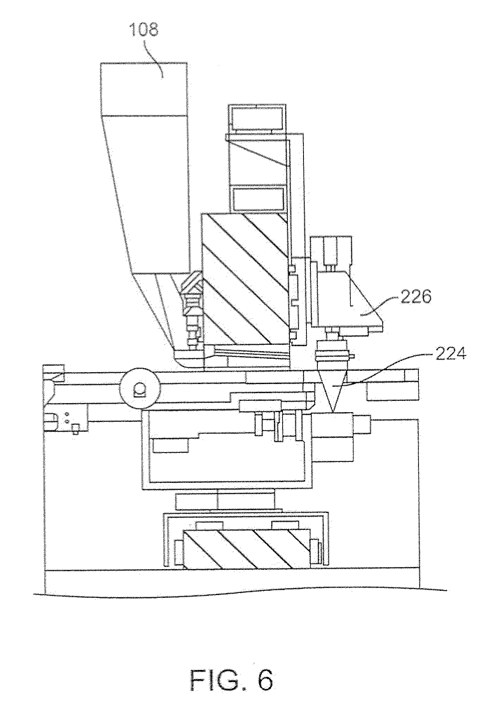

FIG. 6 illustrates a side view of an active region 224 of a laser directed toward the bottom surface of the workpiece. As discussed, the layers are on the opposite side of the workpiece, such that the laser passes through the substrate and scribes the layers on the top side in this arrangement, thus causing the material to ablate off the surface and be extracted by the exhaust 108. As discussed, an imaging device 226 or profiler can image the pattern scribed on the workpiece to ensure proper control of the pulsed beam by the respective scan head. Further, while four lasers are shown with two beam portions each for a total of eight active beams, it should be understood that this is merely exemplary and that any appropriate number of lasers and/or beam portions can be used as appropriate, and that a beam from a given laser can be separated into as many beam portions as is practical and effective for the given application. Further, even in a system where four lasers produce eight beam portions, fewer than eight beam portions can be activated based on the size of the workpiece or other such factors. Optical elements in the scan heads also can be adjusted to control an effective area or spot size of the laser pulses on the workpiece, which in one example vary from about 25 microns to about 100 microns in diameter.

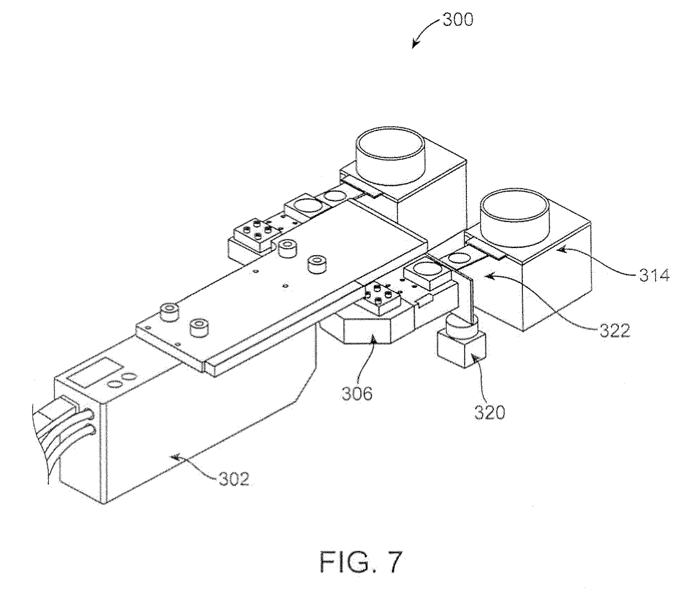

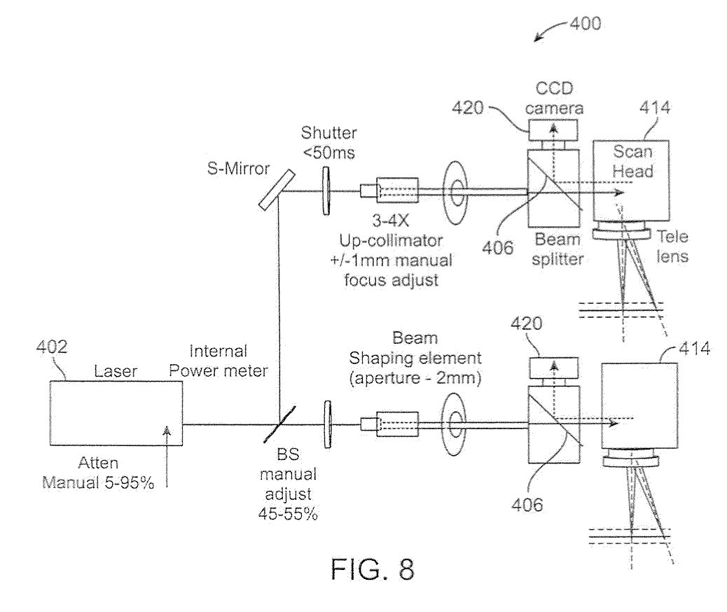

FIG. 7 shows an exemplary laser assembly 300 that can be used by a laser-scribing device to generate a laser-scribed line on a workpiece. The laser assembly 300 includes a laser 302, a beam splitter 306, a scanner 314, and an imaging device 320 mounted between the laser 302 and the scanner 314 so that the imaging device 320 views the workpiece through the scanner 314. The imaging device can be a charge-coupled device such as a CCD camera, a complementary metal-oxide semiconductor (CMOS) image sensor, or any other imaging device know in the art. An imaging device adapter 322 can be used to mount the imaging device 320. The imaging device 320 can be mounted so that the center of its view and the output of the scribing laser 302 point at the same position on a workpiece being targeted by the scanner 314. By mounting the imaging device 320 to view the workpiece through the scanner 314, the scanner 314 can be used to scan the view of the imaging device 320 over the workpiece in the same manner as the scanner 314 is used to scan the output from the laser 302 over the workpiece. By scanning the view of the imaging device 320 over the workpiece, a laser-scribing device can optically observe a previously laser-scribed line and use the acquired positional information to align the position of the output from the scribing laser 302 relative to the previously laser-scribed line on the workpiece. By using an imaging device 320 that is integrated so as to view the workpiece through the scanner 314, the imaging device 320 can sense the position(s) of previously laser-scribed lines relative to the commanded position of the scanner 314, thereby helping to better synchronize the image information relative to where the scanner 314 directs the output of laser 302.

FIG. 8 diagrammatically illustrates an exemplary laser assembly 400. Laser assembly 400 is similar to previously discussed laser assembly 200 of FIG. 4, but further includes two imaging devices 420 (e.g., CCD cameras shown) integrated with the laser assembly 400 so that each of the imaging devices 420 can view the workpiece through an associated scanner 414. As shown, each of the imaging devices 420 can be integrated using a dichromatic beam splitter 406 so as provide an imaging device 420 view direction that substantially corresponds with the direction along which a separate laser beam portion is provided to each of the scanners 414. As discussed above, although a range of relative positions can be practiced, an imaging device 420 can be integrated so that the center of its view and the output of the scribing laser 402 point at the same position on a workpiece being targeted by the scanner 414.

Scribe Alignment

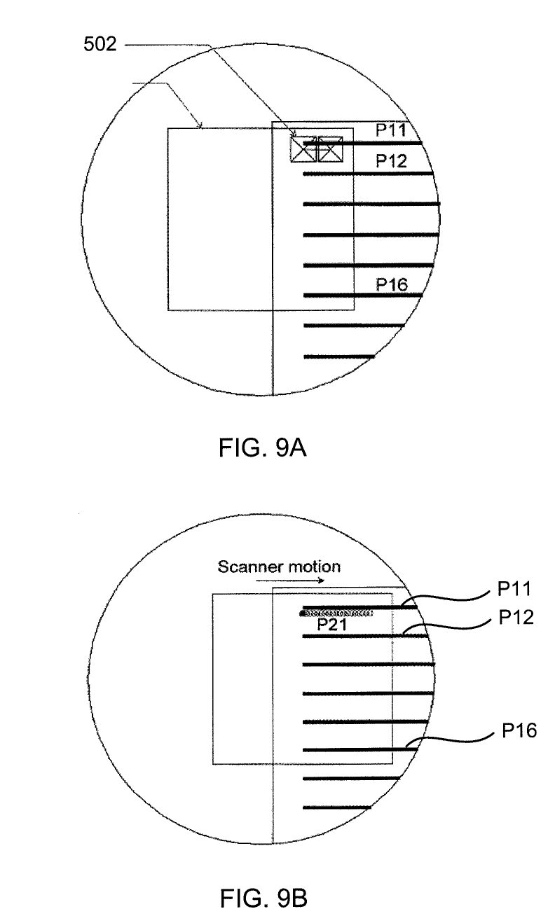

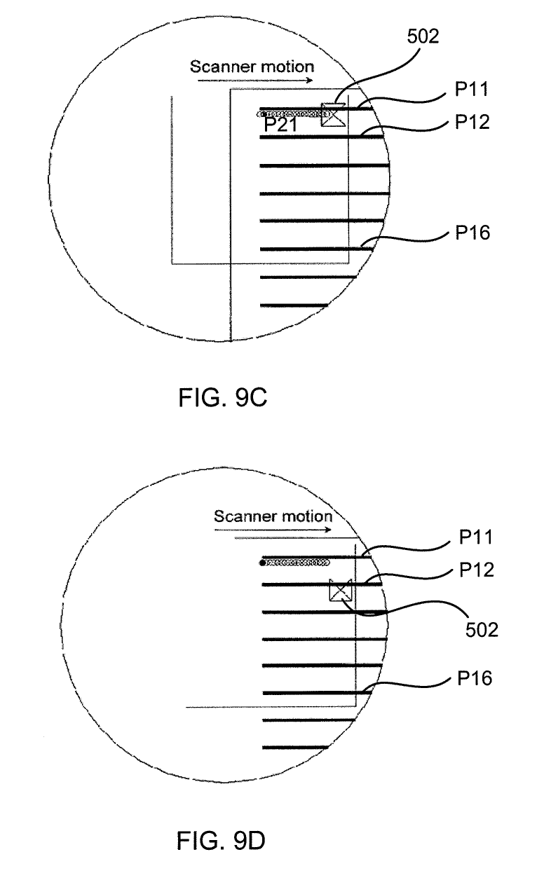

FIG. 9A-9D illustrate how an imaging device, such as the imaging device 420 of FIG. 8, can be used to align the formation of features with previously formed features. As will be described in more detail below, an imaging device can be used to acquired imaging information from the workpiece regarding the position of previously formed laser-scribed lines, such as laser-scribed lines P11 through P16 shown. The laser-scribing device can then use this acquired imaging information to control the scanning of the laser output so as to more closely align subsequently laser-scribed lines (e.g., P2 and/or P3 lines) with previously laser-scribed lines (e.g., P1 and/or P2 lines). The laser-scribing device can use the image-derived information to produce various laser-scribe line configurations, such as longitudinal or latitudinal scribe lines.

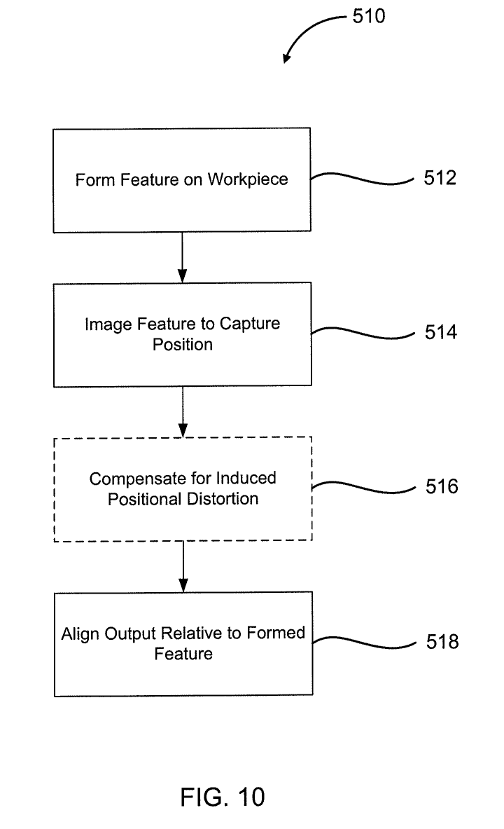

In FIG. 9A, laser-scribed lines P11, P12, . . . P16 have already been formed. With the laser turned off, an imaging device can be used to collect offset data that will be used to align the “to-be scribed” line P21 (shown in FIG. 9B) relative to the “already scribed” line P11. To collect the offset data, the scanner can be used to scan the view 502 of the imaging device along scribe line P11 so as to keep at least a portion of scribe line P11 within the view 502 of the imaging device. Although a number of different paths can be used, it can be advantageous to choose a path such that scribe line P11 is substantially centered in the scanned view 502 of the imaging device, which can help to reduce the amount of scanner induced optical errors, which may arise as will be discussed in more detail below with regard to FIG. 10. In one approach, the scanner can be used to scan the view 502 of the imaging device along where scribe line P11 is estimated to be located. In another approach, the scanner can be used to scan the view 502 of the imaging device along a currently estimated path for “to-be scribed” line P21. Scanning the view 502 of the imaging device along the estimated location of “to-be scribed” line P21 can provide for more direct generation of a scan path for the formation of scribe line P21. Regardless of the specific path used, the offset data contain information sufficient to characterize the form of the “already scribed” line P11, including any curvature, deviations, etc.

Once the offset data for scribe line P11 is obtained, the data can be used to provide a scan path for the scanner so that scribe line P21 is more accurately aligned with scribe line P11. In FIG. 9B, scribe line P21 is laser scribed using the offset data that was collected in the procedure shown in FIG. 9A. In FIG. 9C, laser scribing of line P21 is complete. Then the laser is turned off.

The above described process used to control the scribing of line P21 can be repeated for the remaining “to-be scribed’ lines. For example, as illustrated in FIG. 9D, with the laser turned off, the imaging device can be used to scan the view 502 of the imaging device along “already-scribed” line P12, so as to acquire offset data that can be used to align the “to-be scribed” line P22 relative to the “already scribed” line P12. Scribe line P22 can then be laser scribed using the offset data that was collected.

There are also other possible ways to implement the use of an imaging device to align features with previously formed features. In a second embodiment, an imaging device performs dynamic or “real-time” alignment control by looking at the P11 scribe line directly to determine where the next scribe “dot” on the P21 scribe line should be formed. (Note: It can be seen that each scribe line is actually formed of a series of overlapping scribe “dots,” each being formed by a pulse of the laser directed to a particular position on the workpiece.) Because the scribing laser may produce too much light that might “blind” the imaging device, it may be necessary to shield the imaging device from light reflected from the workpiece. For example, the scribing laser can be turned off whenever the imaging device is used to look at the P11 scribe line. However, turning the imaging device on and off may result in a slow laser-scribing process. As an alternate example, a filter or a shutter can be used to shield the imaging device from the reflected light. An imaging device can also be used that is configured to tolerate the level of reflected light. In a third embodiment, the imaging device performs dynamic or “real-time” alignment control by looking one line ahead on the P12 scribe line, while the P21 line is being scribed. The offset data for the entire P12 scribe line is stored in buffer and retrieved later for the scribing of the P22 line. While the P22 line is being scribed, the imaging device looks ahead to the next scribe line (i.e., P13 scribe line). In a fourth embodiment, the imaging device performs dynamic or “real-time” alignment control by looking several scribe lines ahead (e.g., P11, P12, . . . P16 lines) and storing the offset data for all these scribe lines (e.g., P11, P12, . . . P16 lines) in buffer. This offset data is retrieved later for the scribing of the P21, P22, . . . P26 lines. In a fifth embodiment, the imaging device performs dynamic or “real-time” alignment control by looking an entire block ahead so it is not looking at the same block that is being laser scribed. Consequently, this “look-ahead” imaging device can be separately mounted so that it does not view the workpiece through the scanner. In a sixth embodiment, the imaging device performs dynamic or “real-time” alignment control by looking only at the starting point of the P11 scribe line. Then only the starting point of the P21 scribe line is realigned relative to the starting point of the P11 scribe line for the scribing of the P21 line.

FIG. 10 is a simplified block diagram illustrating a method 510 for aligning output relative to a previously formed feature on a workpiece. In Step 512, a feature is formed on the workpiece. The formation of the feature can be accomplished in a variety of ways, such as by laser scribing a workpiece, welding a workpiece, using an energy source to pattern a workpiece, etc. In step 514, a previously-formed feature on a workpiece is imaged using an imaging device so as to acquire image information that can be used to determine one or more locations of the feature relative to the imaging device. Step 516 is an optional step that can be used, in which compensation for induced positional distortion is accomplished. Induced positional distortions are discussed in more detail below. Compensation for induced positional distortions can be used to improve the location of subsequently formed featured relative to previously formed features by addressing this source of relative positional error. In step 518, the output of a device, such as a laser-scribing device, is aligned relative to the previously-formed features.

Induced Positional Distortions

The use of an imaging device that views the workpiece through a scanner may result in induced positional distortions in the acquired image information. Induced positional distortions may arise due to the optical characteristics of the scanner, such as optical aberrations and optical power. The optical characteristics of the scanner may result in the imaging device being presented with an image that is distorted relative to what actually exists on the workpiece. The optical characteristics of the scanner may also impact the position on the workpiece where the laser output is focused. The combination of any distortions in what the imaging device “sees”, coupled with variations in the position where the laser is focused on the workpiece may impact the systems ability to control the formation of subsequently formed features relative to previously formed features.

One source of induced positional distortion is chromatic aberration. Chromatic aberration is caused by a lens having a different refractive index for different wavelengths of light. Chromatic aberration induced positional distortions may exist due to the wavelength of the laser output being different than the wavelength of light used by the imaging device to locate the features on the workpiece.

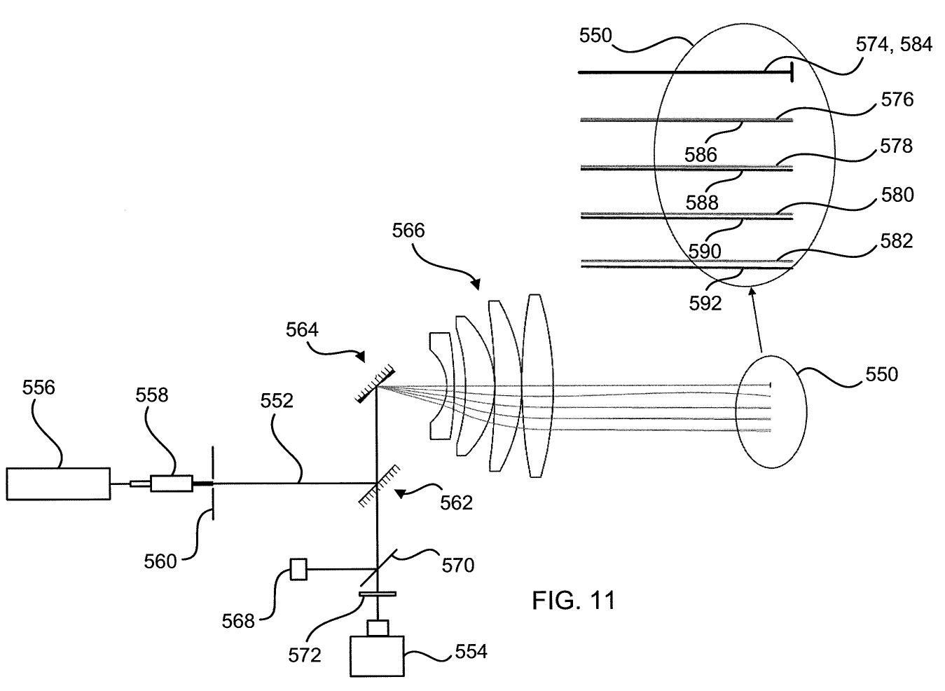

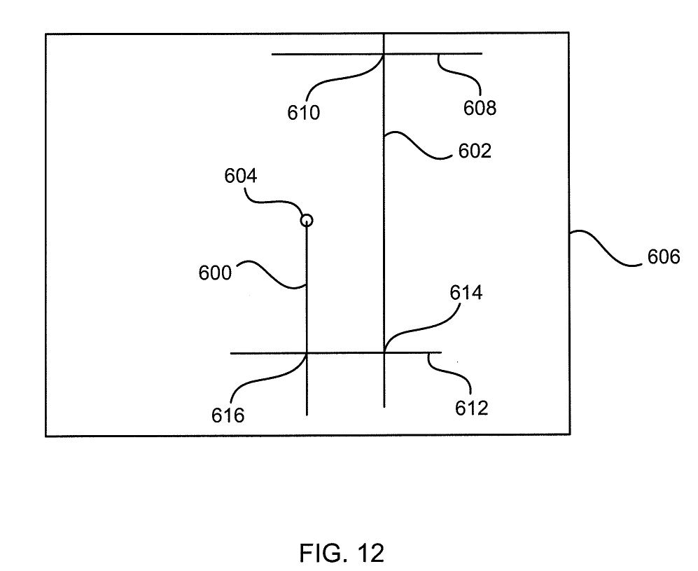

To begin a discussion of induced positional distortions that arise due to chromatic aberration, attention is now directed to FIG. 11. FIG. 11 is a simplified diagram that illustrates a chromatic aberration induced divergence that can occur between a location on a workpiece 550 of a scanned laser output 552 and a corresponding imaged location as seen by an imaging device 554.

As discussed above with reference to FIG. 4, a scanner can include an adjustable mirror that can be used to adjust the position of laser output relative to a workpiece, In the system illustrated in FIG. 11, output from a laser 556 is passed through a beam expander 558. The output from the beam expander 558 is passed through an aperture 560. The resulting laser output 552 is reflected by a dichroic beam splitter 562, which reflects the laser output 552 toward an adjustable mirror 564. The laser output reflected from the adjustable mirror 564 passes through scanning lenses 566 designed to provide a flat field at the image plane of the scanning system. As a result, the laser output 552 is redirected by the scanning lenses 566 so as to be directed substantially orthogonal to the workpiece 550 for any particular scanned position, such as the exemplary first laser-output position 574, second laser-output position 576, third laser-output position 578, fourth laser-output position 580, and fifth laser-output position 582 illustrated. When the adjustable mirror 564 causes the laser output 552 to be directed to the first laser-output position 574, the laser output 552 is directed though the center of the scanning lenses 566 and is not refracted by the scanning lenses 566 to any significant degree. However, when the adjustable mirror 564 causes the laser output 552 to be directed through peripheral portions of the scanning lenses 566, the laser output 552 is refracted by the scanning lenses 566 by a progressively greater amount as can be seen by comparing the laser paths for the various laser output positions shown. Where the laser output 552 has been refracted by the scanning lenses 566, the resulting position of the laser output 552 on the workpiece 550 may be a function of the wavelength of the laser output 552 used due to chromatic aberrations in the scanning lenses 566.

A light-emitting diode 568 can be used to illuminate the workpiece 550 to facilitate imaging of the workpiece 550 by the imaging device 554. Light from the light-emitting diode 568 is reflected towards the adjustable mirror 564 by a 50/50 beam splitter 570. The light from the light-emitting diode reflects off the adjustable mirror 564 towards the workpiece 550, thereby passing through the scanning lenses 566 and illuminating the workpiece 550. Various approaches can be used to illuminate the workpiece, such as by having one or more light-emitting diodes positioned to directly illuminate the workpiece 550. Illumination light reflected from the workpiece 550 passes through the scanning lenses 566 and is reflected by the adjustable mirror 564 towards the imaging device 554 and passes through the dichroic beam splitter 562, the 50/50 beam splitter 570, and a filter 572 prior to reaching the imaging device 554. The dichroic beam splitter 562 reflects laser light while transmitting the illumination light from the light-emitting diode 568. The filter 570 allows the illumination light reflected from the workpiece to pass while blocking laser light reflected from the workpiece.

FIG. 11 includes five exemplary positions for a feature that would be seen by the imaging device 554 as being centered in its field of view. Specifically, these five exemplary positions include a first field-of-view center 584, a second field-of-view center 586, a third field-of-view center 588, a fourth field-of-view center 590, and a fifth field-of-view center 592. These five exemplary positions correspond to the five scanner positions discussed above that would result in the laser being directed to the five laser-output positions shown, specifically the first laser-output position 574, the second laser-output position 576, the third laser-output position 578, the fourth laser-output position 580, and the fifth laser-output position 582 respectively. Thus, for a system where the center-of-view of the imaging device 554 is aligned with the path of the laser provided to the scanner, when the scanner is positioned so as to direct the laser to the first laser-output position 574, any feature on the workpiece located at the first laser-output position 574 would appear to be centered in the field-of-view of the imaging device 554 (i.e., would appear to come from the co-located first field-of-view center 584). This result occurs due to the lack of any significant refraction of either the laser output 552 or of the path of the reflection that is “seen” by the imaging device 554. Since there is no refraction, there is no difference in refraction due to an chromatic aberration of the scanning lenses 566. However, when the adjustable mirror 564 is adjusted to scan the laser output 552 to direct the laser to locations other than the optical centerline of the scanner, chromatic aberrations in the scanning lenses 566 can result in a divergence between the location where the laser output 552 would land on the workpiece 550 and the center of the field-of-view of the imaging device 554.

This chromatic aberration induced divergence can best be illustrated with reference to the fifth laser-output position 582 and the corresponding fifth field-of-view center 592. Both of these positions correspond to where the adjustable mirror 564 directs the laser output 552 to the fifth laser-output position 582. The path of the laser output 552 to the fifth laser-output position 582 travels through peripheral regions of the scanning lenses 566, where it is refracted (bent) in accordance with its wavelength. However, where the imaging device 554 receives reflected illumination radiation from the workpiece 550 with a different wavelength than the laser output 552, the reflected illumination radiation is refracted (bent) in accordance with its wavelength, thereby resulting in a path that is bent to a different degree by the scanning lenses 566. As a result, a feature must actually be located at the fifth field-of-view center 592 to be viewed by the imaging device 554 as being located in the center of its view. The respective first, second, third, fourth, and fifth laser-output positions and the corresponding field-of-view centers illustrate how this divergence increases as the adjustable mirror 564 targets positions progressively further from its center position.

A variety of ways can be used to directly correct for induced positional distortions. In the case of chromatic aberrations, which as discussed above are a function of scanner deflection, the particular scanner deflection used to “image” the feature of the workpiece and the wavelengths of the laser and the reflections imaged by the imaging device can be used to select a compensating positional correction. In general, a functional array of compensating positional corrections can be developed to supply a compensating positional correction for any particular location within the field-of-view of the imaging device at any particular scanner position for the applicable wavelengths used. Such a functional array of compensating positional corrections can consist of a 2-dimensional array of values corresponding to 2-dimensional positions within the imaging device's field of view. The specific values within this 2-dimensional array can be a function of scanner deflection so as to compensate for induced positional distortions generally, such as for the above discussed chromatic aberration induced positional distortions, or any other induced distortion, such as caused by other optical aberration or the optical power of the scanner.

A variety of ways can be used to indirectly correct for induced positional distortions, such as chromatic aberration induced positional distortions. One such approach is best described with reference to FIG. 12, which diagrammatically illustrates the scribing of a second laser-scribed line 600 adjacent to a previously formed first laser-scribed line 602. As the second laser-scribed line 600 is being formed, the scanner is deflected to so that the targeted position 604 on the workpiece 606 is moved so as to generate the second laser-scribe line 600. In the example shown, the targeted position 604 is being moved towards the top of FIG. 12. While the scanner is being “scanned” during the formation of the second laser-scribed line 600, an imaging device can be used to acquire positional information regarding the adjacent previously formed first laser-scribed line 602. As discussed above, the acquisition of positional information can be done in a manner to avoid “blinding” the imaging device with reflected laser output. An exemplary approach involves using a first region-of-interest 608 for the imaging device to acquire a first location 610 for the first laser-scribed line 602. The first region-of-interest 608 for the imaging device can be obtained by selecting a portion of the overall sensing array of the sensing device for monitoring, such as by monitoring one or more particular rows of the total array of data produced by the sensing device. By monitoring only a portion of the total array, increased sample rates can be obtained by avoiding the communication and/or processing time associated with the total array. The exemplary approach further involves using a second region-of-interest 612 to obtain a second location 614 of the first laser-scribed line 602 relative to a location 616 of the second laser-scribed line 600. A relative separation between the second laser-scribe line 600 and the first laser-scribed line 602 as acquired using the second region-of-interest 612 can be compared against a location of the first laser-scribed line 602 as acquired using the first region-of-interest 608 to calculate an amount of compensating correction required to address induced positional distortions, such as chromatic aberration induced positional distortions. For example, a relative separation between the first and second laser-scribed line as acquired using the second region-of-interest 612 can be compared with a corresponding location for the same portion of the first laser-scribed line 602 that was acquired earlier by the first region-of-interest 608 (e.g., when the first region-of-interest 608 encountered second location 614). At least with respect to scanner deflection dependent chromatic aberrations, two or more of these comparisons can be extrapolated to provide an appropriate correction for the current scanner deflection. As will be appreciated by one of skill in the art, the locations acquired by the first and second regions-of-interest can be compared in a variety of ways to provide a compensating correction for the current scanner deflection.

Scribe-Line Width Measurement

The width of a scribed line may be relevant to the fabrication of thin-film solar cells in a number of ways. For example, the width is relevant to solar-cell function because it impacts the electrical isolation of adjacent cells. The width is also relevant to the performance of the scribing laser because more power generally produces a larger laser spot/line. As such, scribe-line width measurement can provide additional data that can be used to control the formation of subsequently-formed scribe lines.

In addition to providing positional data for a previously-formed scribed line, an imaging device can be used to provide width data for the previously-formed scribed line. For example, the scribe line can be illuminated via an illumination source and the imaging device used to capture an image of the illuminated scribe line. The captured image can then be processed to measure a width of the scribe line, for example, by processing a local region of the total array of data produced by the imaging device so as to identify opposing edges of the scribe line and determine the relative distance between the identified opposing edges of the scribe line.

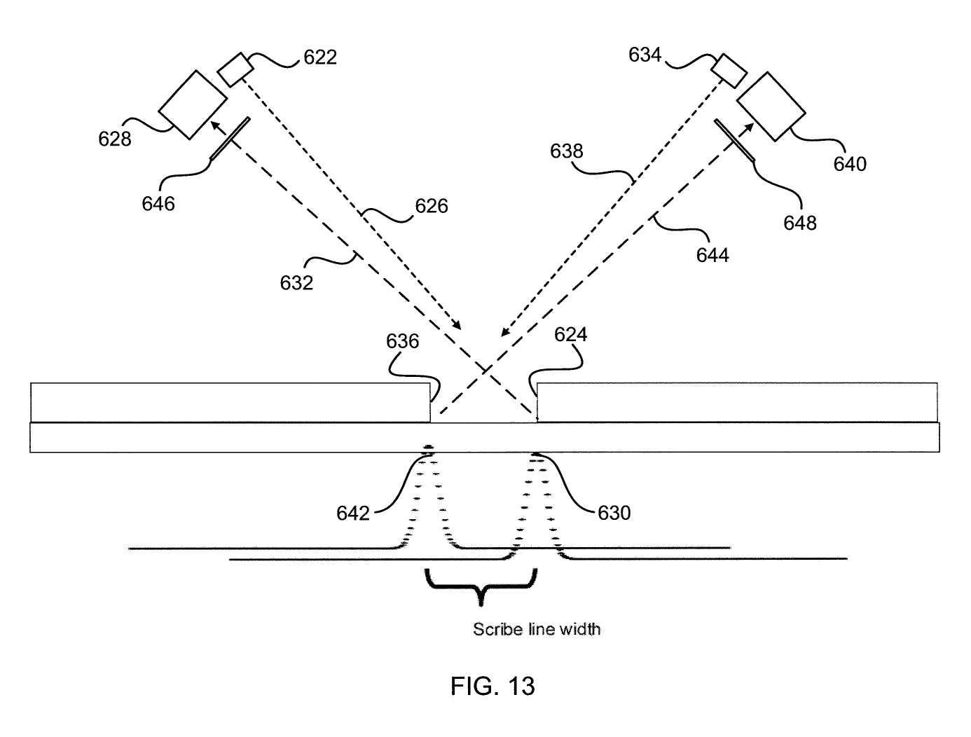

In many embodiments, the laser-scribed line can be measured by using illumination and imaging from two or more directions. FIG. 13 illustrates the use of two directional illumination and two directional imaging to measure a width of a scribe line. The illumination directions used can be selected to enhance the ability to identify line edges during image processing. For example, a first illumination source 622 (e.g., light emitting diode (LED)) can be used to illuminate a scribe-line first edge 624 from a first illumination direction 626. The first illumination direction 626 can be selected such that an image captured by a first imaging device 628 has an intensity peak 630 corresponding to a position of the scribe-line first edge 624. The intensity peak 630 may exactly correspond to the position of the scribe-line first edge 624, or may be offset by some amount from the position of the scribe-line first edge 624. Calibration can be used to measure the amount of any offset involved. The first imaging device 628 can be oriented to capture an image along a first imaging direction 632, which can be the same or different from the first illumination direction 626. A second illumination source 634 (e.g., LED) can be used to illuminate a scribe-line second edge 636 from a second illumination direction 638. The second illumination direction 638 can be selected such that an image captured by a second imaging device 640 has an intensity peak 642 corresponding to the position of the scribe-line second edge 636. The intensity peak 642 may exactly correspond to the position of the scribe-line second edge 636, or may be offset by some amount from the position of the scribe-line second edge 636. Again, calibration can be used to measure the amount of any offset involved. The second imaging device 640 can be oriented to capture an image along a second imaging direction 644, which can be the same or different from the second illumination direction 638. Corresponding images captured by the imaging devices 628, 640 can be processed to measure a scribe-line width. Calibration can be used to provide the processing parameters to generate the scribe-line width in response to the location of the peak intensity 630, 642 on each of the corresponding images.

In many embodiments, a scribed-line width can be measured by using two different illumination wavelengths and two imaging devices configured to selectively process the two different illumination wavelengths. For example, the first illumination source 622 can be configured to illuminate the scribe-line first edge 624 using a first illumination wavelength (e.g., red light) and the second illumination source 634 can be configured to illuminate the scribe-line second edge 636 using a second illumination wavelength (e.g., blue light) that is different from the first illumination wavelength. A first optical filter 646 can be configured to allow the first illumination wavelength to pass while preventing a substantial portion of the second illumination wavelength from passing. Similarly, a second optical filter 648 can be configured to allow the second illumination wavelength to pass while preventing a substantial portion of the first illumination wavelength from passing. Measuring scribe-line width using two different illumination wavelengths as described above may prevent interference between non-corresponding illumination sources and imaging devices during simultaneous imaging of the scribe-line edges 624, 636.

Control Systems

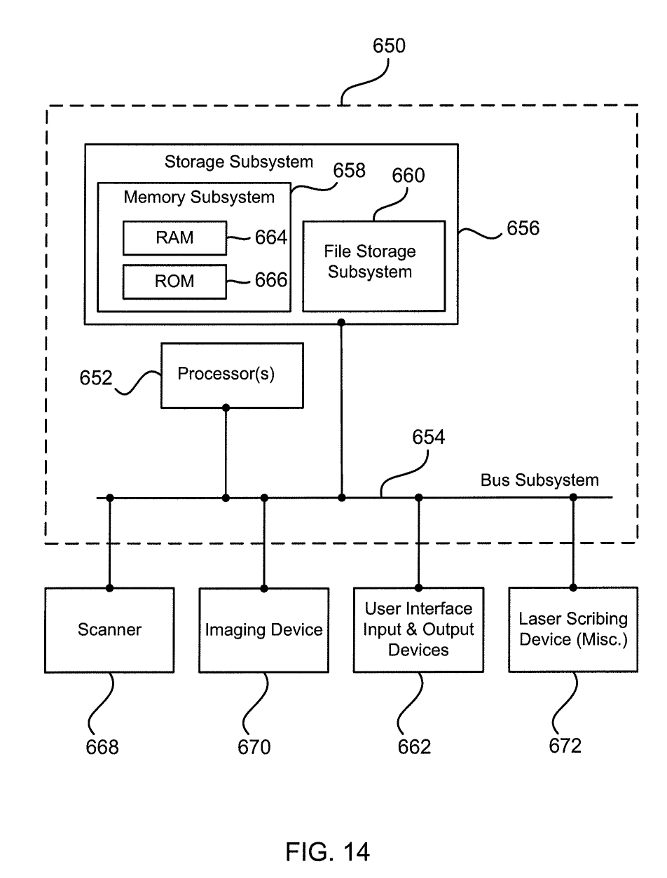

FIG. 14 is a simplified block diagram of a control system 650 that can be used. Control system 650 can include at least one processor 652, which can communicate with a number of peripheral devices via bus subsystem 654. These peripheral devices can include a storage subsystem 656 (memory subsystem 658 and file storage subsystem 660) and a set of user interface input and output devices 662.

The user interface input devices can include a keyboard and may further include a pointing device and a scanner. The pointing device can be an indirect pointing device such as a mouse, trackball, touchpad, or graphics tablet, or a direct pointing device such as a touch screen incorporated into the display. Other types of user interface input devices, such as voice recognition systems, are also possible.

User interface output devices can include a printer and a display subsystem, which can include a display controller and a display device coupled to the controller. The display device can be a cathode ray tube (CRT), a flat-panel device such as a liquid crystal display (LCD), or a projection device. The display subsystem can also provide non-visual display such as audio output.

Storage subsystem 656 can maintain basic programming and data constructs that can be used to control a patterning device. Storage subsystem 656 typically comprises memory subsystem 658 and file storage subsystem 660.

Memory subsystem 658 typically includes a number of memories including a main random access memory (RAM) 664 for storage of instructions and data during program execution and a read only memory (ROM) 666 in which fixed instructions are stored.

File storage subsystem 660 provides persistent (non-volatile) storage for program and data files, and typically includes at least one hard disk drive and at least one disk drive (with associated removable media). There may also be other devices such as a CD-ROM drive and optical drives (all with their associated removable media). Additionally, the system may include drives of the type with removable media cartridges. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Bus subsystem 654 is shown schematically as a single bus, but a typical system has a number of buses such as a local bus and one or more expansion buses (e.g., ADB, SCSI, ISA, EISA, MCA, NuBus, or PCI), as well as serial and parallel ports.

Discussion of the remaining items of FIG. 14 will be omitted here due to being discussed above, such as scanner 668, imaging device 670, and other miscellaneous laser-scribing device 672 components.

It is understood that the examples and embodiments described herein are for illustrative purposes and that various modifications or changes in light thereof will be suggested to persons skilled in the art and are to be included within the spirit and purview of this application and the scope of the appended claims. Numerous different combinations are possible, and such combinations are considered to be part of the present invention.

What is claimed is:

1. A method for laser scribing a workpiece using a laser-scribing device, the workpiece having a first scribed feature, the method comprising:
imaging the workpiece with an imaging device so as to capture a plurality of positions of the first feature on the workpiece relative to the laser-scribing device; and
using the captured positions to align output from the laser-scribing device in order to form a second feature on the workpiece at a controlled distance from the first feature.

2. The method of claim 1, wherein the first feature comprises a scribe line.

3. The method of claim 2, wherein imaging the workpiece captures positional information for the first scribe line, the method further comprising storing the positional information in a memory device.

4. The method of claim 3, wherein the stored positional information is used to perform said aligning output from the laser-scribing device.

5. The method of claim 3, wherein the laser-scribing device comprises a scanning device for aligning output from the laser-scribing device, and wherein the imaging device views the workpiece through the scanning device.

6. The method of claim 5, further comprising compensating for a positional distortion induced by the scanning device.

7. The method of claim 6, wherein said compensating comprises:
using a first region-of-interest of the imaging device to acquire a first position of the first feature;
using a second region-of-interest of the imaging device to acquire a second position of the first feature; and
using the second region-of-interest to acquire a first position of the second feature.

8. The method of claim 2, wherein said captured plurality of positions comprises a position of a first edge of the scribe line and a position of an opposing second edge of the scribe line, and wherein said using the captured positions to align output comprises using the positions of the first and second edges to generate a width for the scribe line.

9. The method of claim 8, further comprising using said width to control laser-scribing device output power.

10. The method of claim 8, wherein said imaging the workpiece further comprises:
illuminating the first edge of the scribe line with light comprising a first wavelength;
imaging the first edge of the scribe line with a first imaging device;
illuminating the second edge of the scribe line with light comprising a second wavelength, the second wavelength being different from the first wavelength; and
imaging the second edge of the scribe line with a second imaging device.

11. The method of claim 10, wherein:
said imaging the first edge of the scribe line with a first imaging device comprises filtering reflected light from the workpiece to substantially block the second wavelength from entering the first imaging device; and
said imaging the second edge of the scribe line with a second imaging device comprises filtering reflected light from the workpiece to substantially block the first wavelength from entering the second imaging device.

12. A system for laser scribing a workpiece having a first scribed feature, the system comprising:
a laser operable to generate output able to remove material from at least a portion of the workpiece;
a scanning device operable to control a position of the output from the laser relative to the workpiece;
an imaging device having a pre-determined orientation relative to the scanning device; and
a control device coupled with the laser, the scanning device and the imaging device, the control device comprising a processor and a machine-readable medium comprising instructions that when executed by the processor cause the system to:
image the workpiece using the imaging device so as to capture a plurality of positions of the first feature on the workpiece; and
use the captured positions to align the laser output using the scanning device in order to form a second feature on the workpiece at a controlled distance from the first feature.

13. The system of claim 12, wherein the workpiece includes a substrate and at least one layer used for forming a solar cell, and the laser is able to remove material from the at least one layer.

14. The system of claim 13, wherein said first and second features comprise a laser-scribed line.

15. The system of claim 12, wherein the imaging device views the workpiece through the scanning device.

16. The system of claim 15, wherein the imaging device images an area that includes a current target position for the output from the laser.

17. The system of claim 16, wherein the current target position for the output from the laser is approximately centered in a field of view of the imaging device.

18. The system of claim 15, wherein the system compensates for a positional distortion induced by the scanning device.

19. The system of claim 18, wherein the positional distortion comprises a chromatic aberration induced positional distortion.

20. The system of claim 18, wherein the system compensates for the induced positional distortion based upon:
a location of the first feature acquired by a first region-of-interest of the imaging device;
a location of the first feature acquired by a second region-of-interest of the imaging device; and
a location of the second feature acquired by the second region-of-interest of the imaging device.

21. The system of claim 18, wherein the system compensates for an optical power induced positional distortion.

22. The system of claim 18, wherein the system compensates for an optical aberration induced positional distortion.

23. The system of claim 12, wherein an integral unit comprises the imaging device and the scanning device.

24. The system of claim 12, wherein said captured plurality of positions comprises a position of a first edge of a scribe line and a position of an opposing second edge of the scribe line, wherein said use of the captured positions to align the laser output comprises using the positions of the first and second edges to generate a width for the scribe line.

25. The system of claim 24, wherein said instructions, when executed by the processor, further cause the system to use said width to control laser output power.

26. The system of claim 12, wherein said captured plurality of positions comprises a position of a first edge of a scribe line, and wherein the system further comprises:
a first illumination source configured to illuminate the first edge of the scribe line with light comprising a first wavelength;
a second illumination source configured to illuminate an opposing second edge of the scribe line with light comprising a second wavelength, the second wavelength being different from the first wavelength; and
a second imaging device configured to capture a position of the opposing second edge of the scribe line.

27. The system of claim 26, further comprising:
a first optical filter configured to:
filter light reflected from the workpiece imaged by the imaging device,
permit passage of the first wavelength, and
substantially block the second wavelength; and
a second optical filter configured to:
filter light reflected from the workpiece imaged by the second imaging device,
permit passage of the second wavelength, and
substantially block the first wavelength.

28. A system for aligning an energy source for patterning a workpiece having a first formed feature, comprising:
an energy source operable to generate output able to contribute to the formation of a feature on the workpiece;
a scanning device operable to control a position of the output from the energy source relative to the workpiece;
an imaging device having a pre-determined orientation relative to the scanning device, the imaging device being operable to image a feature on the workpiece; and
a control device coupled with the energy source, the scanning device and the imaging device, the control device comprising a processor and a machine-readable medium comprising instructions that when executed by the processor cause the system to:
image the workpiece using the imaging device so as to capture a plurality of positions of the first feature on the workpiece; and
use the captured positions to align the energy source output using the scanning device in order to form a second feature on the workpiece at a controlled distance from the first feature.
